(19) United States
(12) Patent Application Publication
(10) Pub. No.: US 2018/0238074 A1
(43) Pub. Date: Aug. 23, 2018

(54) STICK FLAG SAFETY FINIAL

(71) Applicant: FLAG FINIALS, INC., Marietta, GA (US)

(72) Inventor: Steven Richard EHRLICH, Marietta, GA (US)

(73) Assignee: FLAG FINIALS, INC., Marietta, GA (US)

(21) Appl. No.: 15/890,082

(22) Filed: Feb. 6, 2018

Related U.S. Application Data
(60) Provisional application No. 62/600,266, filed on Feb. 18, 2017.

(51) Int. Cl. E04H 12/32; E04H 12/02

(52) U.S. Cl. CPC E04H 12/32; G09F 17/00; E04H 12/02

(57) ABSTRACT

A safety finial for a stick flag includes a receiver collar for engagement with a flag stick of the stick flag, and a finial tip comprising a soft and deformable resilient material, to reduce the potential for injury or damage from contact with the finial. Also, a plastic flag stick for a stick flag, which has a polygonal cross-sectional configuration; and a stick flag including one or both of the safety finial and/or the plastic flag stick.

### CROSS-REFERENCE TO RELATED APPLICATION

This application claims the benefit of U.S. Provisional Patent Application Ser. No. 62/600,266 filed Feb. 18, 2017, the entirety of which is hereby incorporated herein by reference for all purposes.

### TECHNICAL FIELD

The present invention relates generally to the field of stick flags, and more particularly to a flag finial constructed of a deformable or compressible material, a flag stick or post comprising a hexagonal or other polygonal plastic extrusion, and/or a stick flag or other type of flag or banner incorporating one or both of these components.

### BACKGROUND

A “stick flag” is a representation of any flag or banner, attached to a stick, generally intended to be hand-held or for portable hand placement at a display site. For example, flags or banners may be produced in rectangular dimensions such as about 4″×6″, 8″×12″, 12″×18″, triangular banners, or other shapes and sizes suited for handheld or portable usage, and commonly stapled, glued or otherwise affixed to a wooden dowel or stick having a length of about 10″, 24″, 30″ or 36″.

A finial or cap may be permanently bonded to the top end of the stick, above the flag or banner, with a staple, wire, stitch, brad, a mastic or other adhesive. Previously known finials have generally been constructed using “hard” and physically unyielding materials (wood, metal, plastic, etc.), resulting in a potential dangerous situation if the hand-held flag is pushed or impacted into the body of another person. For example, a child or adult vigorously waving a stick flag with a hard-pointed finial may poke or hit an adjacent bystander in the face or eye, causing potential injury.

Finials and sticks of previously known stick flags may also fade, splinter and crack over time, or paint applied thereto may chip or peel, detracting from the products' appearance and utility. Also, manufacture of wooden finials and wooden dowel sticks may be more expensive than desired for a low-cost item. And some users may find standard wooden dowel sticks of flags difficult to grip.

Accordingly, it has been found that needs exist for improvements to stick flags and components thereof, for example providing increased safety, improved appearance, better utility, increased durability, lower manufacturing costs, ease of use, and/or other advantages. It is to the provision of improvements to stick flags and components thereof meeting these and other needs that the present invention is primarily directed.

### SUMMARY

The present invention includes the provision of cap top points (finials) for hand-held flags, said points being formed of molded, relatively soft plastics, in any shape or design. These soft finials are used in lieu of conventional metallic, wood, or hard plastic points. In example embodiments, this invention manufactures the finial from a material designed to “yield” to pressure and “give way” by deforming the material enough to avoid or reduce injury. The employment of relatively soft plastic finials or flag points results in several advantages over conventional wooden or hard-plastic points and the like. The invention's plastic points are intended to deform when thrust into a person or object, thereby causing less potential for injury or damage than a hard finial or point. The soft finial material may also provide increased durability and improved appearance and utility, resisting fading or chipping over time, and improved economics of manufacture. The soft-plastic safety finials may be cast in multiple shapes, sizes and colors for improved aesthetics and function.

The invention also includes the provision of a plastic flag stick or post, for example a plastic extrusion of hexagonal or other polygonal cross-sectional profile, for use in place of the typical round wooden dowel flag stick. The polygonal plastic dowel may provide improved appearance and durability, lower cost, and/or be easier for a user to grip.

In example embodiments, the present invention provides an improved safety finial for a stick flag, an improved stick for a stick flag, and/or an improved stick flag incorporating one or both of these components.

In one aspect, the present invention relates to a stick flag. In example embodiments, the stick flag preferably includes a flag stick having an elongate body with a polygonal cross-sectional configuration, a proximal end comprising a gripping section, and a distal tip end opposite the proximal end. The stick flag preferably also includes a flag attached to the flag stick above the gripping section and below the distal tip end. The stick flag preferably also includes a safety finial attached at the distal tip end of the flag stick, the safety finial comprising a soft and deformable resilient material.

In another aspect, the invention relates to a safety finial for a stick flag. The safety finial preferably may include a receiver collar for engagement with a flag stick of the stick flag, and a finial tip at least partially formed from a soft and deformable resilient material.

In still another aspect, the invention relates to a flag stick for a stick flag. The flag stick preferably includes an elongate body having a polygonal cross-sectional configuration, a proximal end providing a gripping section, and a distal tip end opposite the proximal end for engagement with a flag finial.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 shows a side view of a stick flag having an extruded polygonal plastic flag stick and a resilient soft ball finial, according to an example embodiment of the invention.

FIG. 2 shows a side view of a stick flag having a resilient blunt spear-tip finial, according to another example embodiment of the invention.

FIG. 3 shows a perspective view of an extruded polygonal plastic flag stick having a resilient soft flag finial mounted thereon, according to an example embodiment of the invention.

FIG. 4 shows an example range of deformation upon application of force or pressure to a resilient soft flag finial, according to an example embodiment of the invention.

FIG. 5 shows an example manner of use of a resilient soft flag finial according to an example embodiment of the invention, deforming upon impact with a person, to reduce the potential for injury.

FIG. 6 shows a cross-sectional view of a soft ball finial for a stick flag, according to an example embodiment of the invention.

FIG. 7 shows a cross-sectional view of a resilient blunt spear-tip flag finial, according to an example embodiment of the invention.

FIG. 8 shows the resilient deformation of a soft ball finial upon contact with an object, according to an example embodiment of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

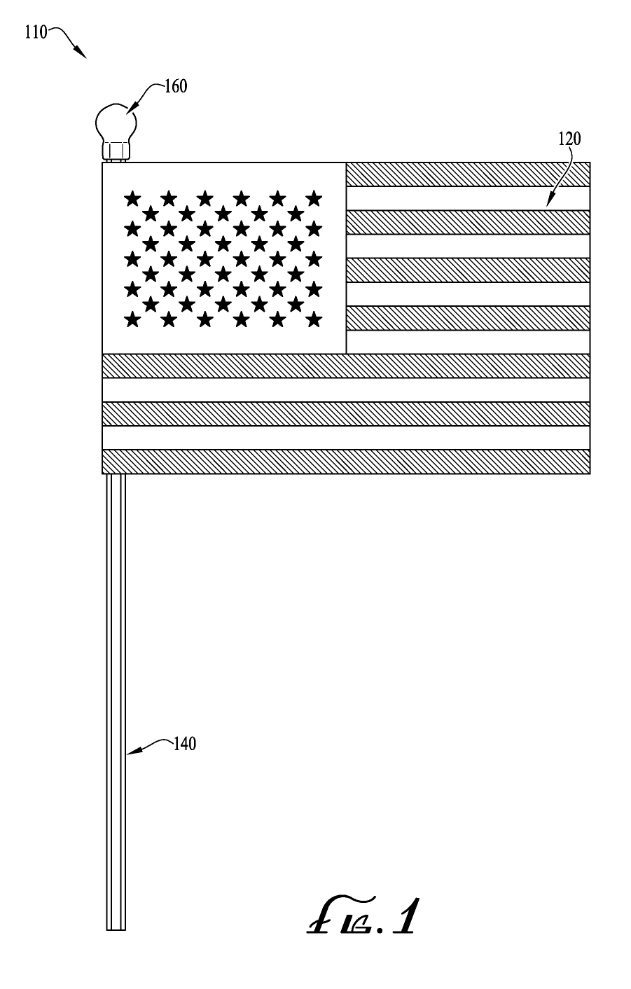

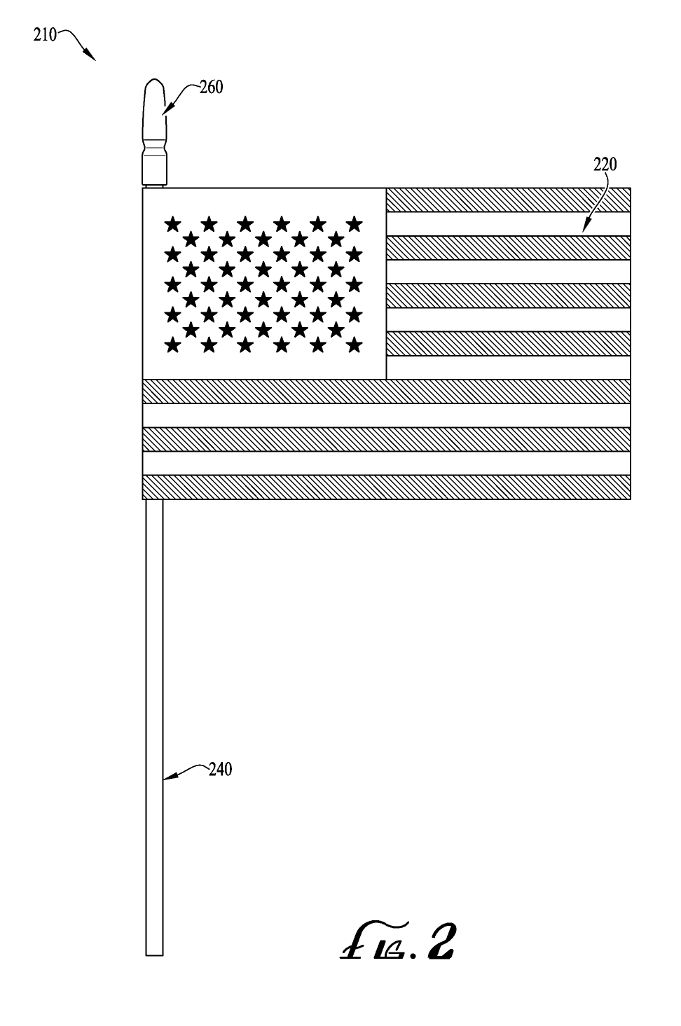

With reference now to the drawing figures, wherein like reference numbers represent corresponding parts throughout the several views, FIGS. 1 and 2 show stick flags 110, 210 according to example embodiments of the present invention. The stick flags 110, 210 generally comprise a flag or banner portion 120, 220, affixed to a stick or post 140, 240, the top end of which is surmounted with a finial 160, 260.

The depicted embodiments show a small United States flag as the flag or banner portion 120, 220, but in other embodiments, different formats of flags or banners may be utilized. For example, the flags or banners 120, 220 may comprise panels of fabric, plastic sheeting, paper or other thin flexible material, formed in rectangular dimensions such as about 4″×6″, 8″×12″, 12″×18″, triangular banners, or other shapes and sizes suited for handheld or portable usage or placement. The flags or banners 120, 220 may be printed, died, embroidered and/or otherwise provided with a desired pattern or appearance of one or more colors, shapes, text or other indicia.

In example embodiments, the flags or banners 120, 220 may be stapled, glued or otherwise affixed to the stick or post 140, 240. In example embodiments, the finials 160, 260 have bases with female receiver openings that allow the top end of the stick or post 140, 240 to be inserted therein, and the finial and stick glued together with a mastic or other adhesive, or otherwise attached, to permanently or semi-permanently attach the finial to the flag stick.

In example embodiments, the stick or post 140, 240 is an elongate member suited for handheld use or portable hand placement, for example having a length of about 10″, 24″, 30″ or 36″. The stick or post 140, 240 may be fabricated from wood, plastic, metal, composites, and/or other materials. For example, the stick or post 140 of the embodiment in FIG. 1 is formed as a plastic extrusion, shown and described in greater detail below with reference to FIG. 3, whereas the stick or post 240 of the embodiment of FIG. 2 is a wooden dowel having, for example, a circular cross-sectional profile of about 3/16″, ¼″ or other diameter suitable for handheld gripping by a user. A first or proximal end of the flag stick provides a gripping surface or portion for a user to manually grasp toward the bottom of the stick flag, for example to wave or place the flag during use. An opposite second or distal end of the flag stick defines the upper tip to which the finial is mounted above the flag. The body of the flag stick extends generally linearly along a lengthwise axis between the first and second ends.

FIG. 3 shows the stick or post 140 of FIG. 1 in greater detail. The stick or post 140 generally comprises an elongate plastic extrusion or molding having a hexagonal cross-sectional profile, with six regularly spaced flats 142, optionally including recessed grooves or fluting 144 at the intersections of the flats, thereby providing improved gripping surfaces for a user holding the flag. The stick or post 140 may have a thickness, for example, of about 3/16″, ¼″, ⅝″ or other transverse dimension between external surfaces of oppositely positioned flats 142. The stick or post 140 may be of solid construction, or be hollow as depicted, having a central lumen 146 extending axially through its length. While depicted as hexagonal, the stick or post 140 may be of triangular, square, pentagonal, octagonal or other polygonal cross-sectional configuration, or may have a circular, oval, flat bar or other cross-sectional shape. The flag stick or post 140 is optionally imprinted, engraved, embossed, molded or otherwise provided with a decorative pattern, text, graphics, or other material, such as for example a “Made in USA” indicia, “Thank You to Our Veterans” message, or the like.

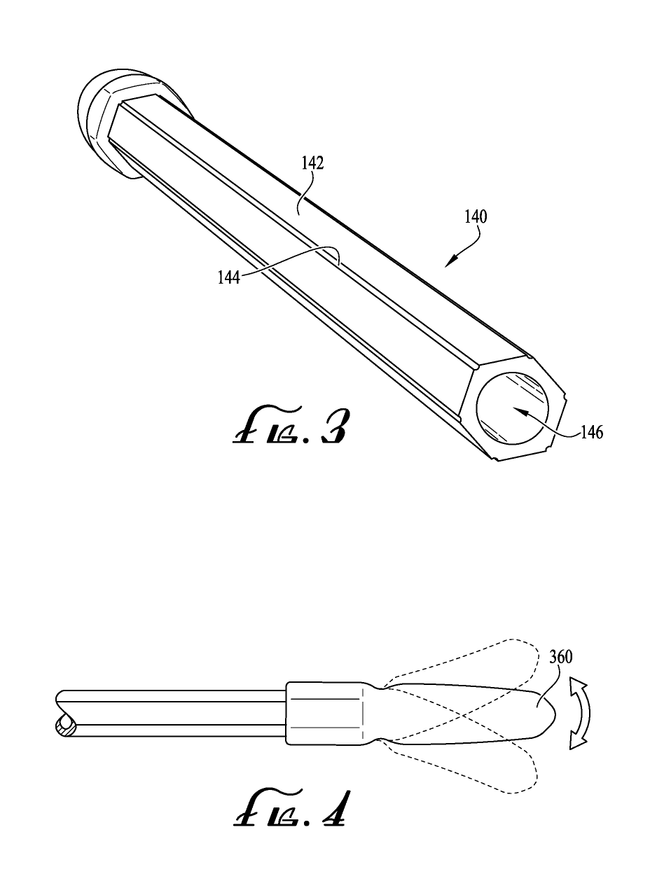

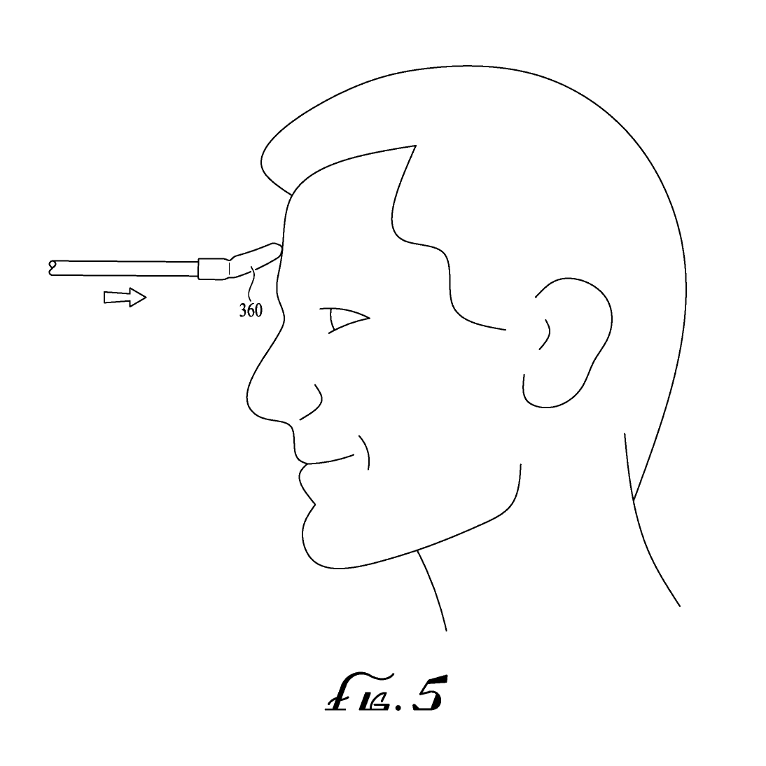

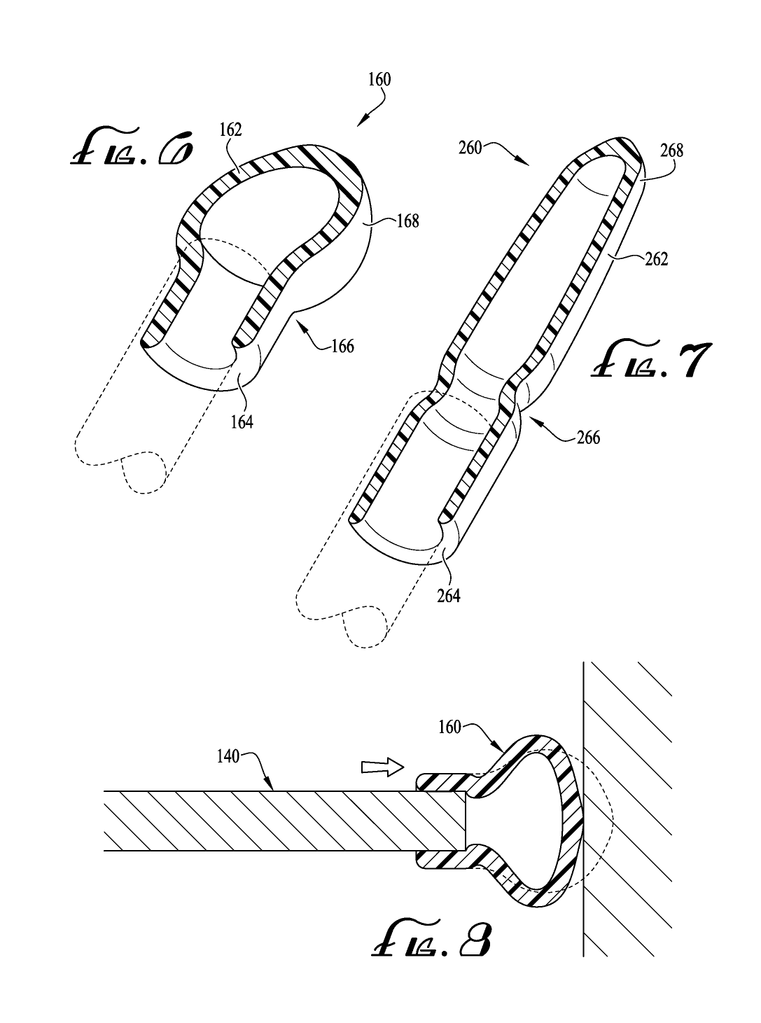

FIGS. 4 and 5 show the deformation or compressibility upon pressure or impact of a soft flag finial 360, according to example forms and modes of use of the invention, and FIGS. 6 and 7 show detailed cross-sectional views of the soft flag finials 260, 160 of FIG. 2 and FIG. 1, respectively. In example embodiments, the soft flag finials of the present invention comprise moldings of soft plastic, natural or synthetic rubber, vinyl, and/or other resilient, compressible and/or deformable polymeric materials. In particular embodiments, the soft flag finials of the present invention are formed by dip-molding or injection molding. In example forms, the soft flag finials resiliently compress or deform by at least about 10%, and more preferably about 15%-50%, for example about 20%-30% upon application of moderate to hard manual pressure or hand force by a user, for example an applied force of about 3-10 lbs., for example about 5 lbs. For example, as depicted in FIGS. 4 and 5, the elongate blunt spear tip type of soft flag finials resiliently compress or deform by about 5°-30° out of alignment with their neutral (undeformed) axes, for example about 15°, upon application of moderate to hard manual pressure or hand force by a user. Similarly, as shown in FIG. 8, the soft ball type flag finials resiliently compress or deform inwardly upon application of moderate to hard manual pressure or hand force by a user. In example embodiments, the finial is substantially entirely formed from a soft and deformable resilient material. In alternate embodiments, the tip and/or other exterior portion(s) of the finial are formed from a soft and deformable resilient material, and the mounting base and/or internal portion(s) of the finial are formed from a hard or rigid material.

As seen with reference to FIGS. 6 and 7, the soft finials 160, 260 according to the present invention can be fabricated as substantially hollow moldings having an outer shell 162, 262 surrounding an open inner chamber or void, or alternatively may comprise a solid molding, casting, or otherwise formed body. The soft finials 160, 260 preferably comprise a female receiver or sleeve forming an open collar 164, 264 configured to engage the top end or tip of the flag stick or post. In example embodiments, the receiver collar is generally cylindrical, having a circular cross-section, and defines an inside dimension configured to receive the flag stick or post of specified outside dimension with a close running or interference fit. Alternatively, the receiver collar may be formed with a polygonal or otherwise shaped inside configuration adapted to fit a correspondingly shaped flag stick or post. Optionally, the receiver collar is constructed of a resilient material and configured to stretch to fit over and engage the tip of the flag stick or post, enabling it to be retained on the stick or post with or without adhesive or other attachment means. In example forms, the soft finials may incorporate one or more recesses, transitions or other relief portions to provide an increased degree of resilient flexure or compression upon application of force or pressure. For example, in the example embodiment of FIG. 6, the finial 160 includes a circumferential transition 166 around its base between its receiver collar and its ball tip 168; and in the example embodiment of FIG. 7, the finial 260 includes a circumferential recess 266 of reduced dimension around its base between its receiver collar and its blunt spear tip 268. The safety finials 160, 260 comprise ornamental tip configurations, such as a generally spherical ball tip (ball finial 160), an elongate axially tapering blunt spear tip (finial 260), or other suitable resiliently deformable finial tip configurations.

While the invention has been described with reference to example embodiments, it will be understood by those skilled in the art that a variety of modifications, additions and deletions are within the scope of the invention, as defined by the following claims.

What is claimed is:

1. A stick flag comprising:
a flag stick comprising an elongate body having a polygonal cross-sectional configuration, a proximal end comprising a gripping section, and a distal tip end opposite the proximal end;
a flag attached to the flag stick above the gripping section and below the distal tip end;
a safety finial attached at the distal tip end of the flag stick, the safety finial comprising a soft and deformable resilient material.

2. The stick flag of claim 1, wherein the flag stick comprises a hollow plastic molding.

3. The stick flag of claim 1, wherein the flag stick has a hexagonal cross-sectional configuration.

4. The stick flag of claim 1, wherein the flag comprises a national flag.

5. The stick flag of claim 4, wherein the flag comprises the flag of the United States of America.

6. The stick flag of claim 1, wherein the safety finial comprises a blunt spear-tip point configuration.

7. The stick flag of claim 1, wherein the safety finial comprises a ball configuration.

8. The stick flag of claim 1, wherein the safety finial comprises a receiver collar configured to receive the distal tip end of the flag stick with a close fit therebetween.

9. The stick flag of claim 1, wherein the safety finial comprises a recessed relief portion about which the safety finial deforms.

10. The stick flag of claim 1, wherein the safety finial resiliently deforms by at least about 10% upon application of moderate to hard manual pressure.

11. A safety finial for a stick flag, the safety finial comprising a receiver collar for engagement with a flag stick of the stick flag, and a finial tip comprising a soft and deformable resilient material.

12. The safety finial of claim 11, wherein the finial tip comprises a blunt spear-tip point configuration.

13. The safety finial of claim 11, wherein the finial tip comprises a ball finial configuration.

14. The safety finial of claim 11, further comprising a recessed portion between the receiver collar and the finial tip, about which the safety finial deforms.

15. The safety finial of claim 11, wherein the finial tip resiliently deforms by at least about 10% upon application of moderate to hard manual pressure.

16. A flag stick for a stick flag, the flag stick comprising an elongate body having a polygonal cross-sectional configuration, a proximal end comprising a gripping section, and a distal tip end opposite the proximal end for engagement with a flag finial.

17. The flag stick of claim 16, comprising a hollow plastic molding.

18. The flag stick of claim 16, having a hexagonal cross-sectional configuration.
